(19) United States
(12) Patent Application Publication
(10) Pub. No.: US 2021/0203995 A1
(43) Pub. Date: Jul. 1, 2021

(54) VIDEO DECODING METHOD FOR DECODING BITSTREAM TO GENERATE PROJECTION-BASED FRAME WITH GUARD BAND TYPE SPECIFIED BY SYNTAX ELEMENT SIGNALING

(71) Applicant: MEDIATEK INC., Hsin-Chu (TW)

(72) Inventors: Ya-Hsuan Lee, Hsinchu City (TW); Jian-Liang Lin, Hsinchu City (TW)

(21) Appl. No.: 17/134,551

(22) Filed: Dec. 28, 2020

Related U.S. Application Data
(60) Provisional application No. 62/954,814, filed on Dec. 30, 2019.
(60) Provisional application No. 62/980,464, filed on Feb. 24, 2020.

(51) Int. Cl. H04N 19/70; H04N 19/597

(52) U.S. Cl. CPC H04N 19/70; H04N 19/597

(57) ABSTRACT

A video decoding method includes: decoding a part of a bitstream to generate a decoded frame, including parsing a syntax element from the bitstream. The decoded frame is a projection-based frame that includes at least one projection face and at least one guard band packed in a projection layout with padding, and at least a portion of a 360-degree content of a sphere is mapped to the at least one projection face via projection. The syntax element specifies a guard band type of the at least one guard band.

### CROSS REFERENCE TO RELATED APPLICATIONS

This application claims the benefit of U.S. provisional application No. 62/954,814 filed on Dec. 30, 2019 and U.S. provisional application No. 62/980,464 filed on Feb. 24, 2020. The entire contents of the related applications, including U.S. provisional application No. 62/954,814 and U.S. provisional application No. 62/980,464, are incorporated herein by reference.

### BACKGROUND

The present invention relates to video processing, and more particularly, to a video decoding method for decoding a bitstream to generate a projection-based frame with a guard band type specified by syntax element signaling.

Virtual reality (VR) with head-mounted displays (HMDs) is associated with a variety of applications. The ability to show wide field of view content to a user can be used to provide immersive visual experiences. A real-world environment has to be captured in all directions, resulting in an omnidirectional video corresponding to a viewing sphere. With advances in camera rigs and HMDs, the delivery of VR content may soon become the bottleneck due to the high bitrate required for representing such a 360-degree content. When the resolution of the omnidirectional video is 4K or higher, data compression/encoding is critical to bitrate reduction.

In general, the omnidirectional video corresponding to a sphere is transformed into a frame with a 360-degree image content represented by one or more projection faces arranged in a 360-degree Virtual Reality (360 VR) projection layout, and then the resulting frame is encoded into a bitstream for transmission. If a configuration of the employed 360 VR projection layout is signaled from an encoder side to a decoder side, the rendering process and post-processing process at the decoder side may use the signaled frame configuration information to improve the video quality. Thus, there is a need for an innovative video decoding design which determines a guard band type of guard band(s) packed in a projection-based frame by parsing a syntax element associated with the guard band type from a bitstream.

### SUMMARY

One of the objectives of the claimed invention is to provide a video decoding method for decoding a bitstream to generate a projection-based frame with a guard band type specified by syntax element signaling.

According to a first aspect of the present invention, an exemplary video decoding method is disclosed. The exemplary video decoding method includes: decoding a part of a bitstream to generate a decoded frame, comprising parsing a syntax element from the bitstream. The decoded frame is a projection-based frame that comprises at least one projection face and at least one guard band packed in a projection layout with padding, and at least a portion of a 360-degree content of a sphere is mapped to said at least one projection face via projection. The syntax element specifies a guard band type of said at least one guard band.

According to a second aspect of the present invention, an exemplary video decoding method is disclosed. The exemplary video decoding method includes: decoding a part of a bitstream to generate a decoded frame. The decoded frame is a projection-based frame that comprises at least one projection face and at least one guard band packed in a projection layout with padding, and at least a portion of a 360-degree content of a sphere is mapped to said at least one projection face via projection. The projection layout with padding comprises a padding region and a non-padding region, said at least one projection face is packed in the non-padding region, said at least one guard band is packed in the padding region, and all padding pixels in a corner area of the padding region have a same value.

According to a third aspect of the present invention, an exemplary video decoding method is disclosed. The exemplary video decoding method includes: decoding a part of a bitstream to generate a decoded frame. The decoded frame is a projection-based frame that comprises at least one projection face and at least one guard band packed in a projection layout with padding, and at least a portion of a 360-degree content of a sphere is mapped to said at least one projection face via projection. The projection layout with padding comprises a padding region and a non-padding region, said at least one projection face is packed in the non-padding region, said at least one guard band is packed in the padding region, and a corner area of the padding region comprises a plurality of padding pixels and is a duplicate of an area that is outside the corner area of the padding region.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a 360-degree Virtual Reality (360 VR) system according to an embodiment of the present invention.

FIG. 2 is a diagram illustrating a cube-based projection according to an embodiment of the present invention.

FIG. 3 is a diagram illustrating another cube-based projection according to an embodiment of the present invention.

FIGS. 4-6 are diagrams illustrating one specification of guard bands packed in a regular cubemap projection or a hemisphere cubemap projection according to an embodiment of the present invention.

FIGS. 7-9 are diagrams illustrating another specification of guard bands packed in a regular cubemap projection or a hemisphere cubemap projection according to an embodiment of the present invention.

FIG. 10 is a diagram illustrating one specification of guard bands packed in an equi-rectangular projection layout or an equi-area projection layout according to an embodiment of the present invention.

FIG. 11 is a diagram illustrating another specification of guard bands packed in an equi-rectangular projection layout or an equi-area projection layout according to an embodiment of the present invention.

FIG. 12 is a diagram illustrating a first guard band type according to an embodiment of the present invention.

FIG. 13 is a diagram illustrating a second guard band type according to an embodiment of the present invention.

FIG. 14 is a diagram illustrating a second guard band type according to another embodiment of the present invention.

FIG. 15 is a diagram illustrating a third guard band type according to an embodiment of the present invention.

FIG. 16 is a diagram illustrating a padding region with corners filled with padding pixels according to an embodiment of the present invention.

FIG. 17 is a diagram illustrating a first duplication scheme for setting values of padding pixels in one corner area of a padding region according to the first exemplary corner padding method.

FIG. 18 is a diagram illustrating a second duplication scheme for setting values of padding pixels in one corner area of a padding region according to the first exemplary corner padding method.

FIG. 19 is a diagram illustrating a third duplication scheme for setting values of padding pixels in one corner area of a padding region according to the first exemplary corner padding method.

FIG. 20 is a diagram illustrating a fourth duplication scheme for setting values of padding pixels in one corner area of a padding region according to the first exemplary corner padding method.

FIG. 21 is a diagram illustrating a blending scheme for setting values of padding pixels in one corner area of a padding region according to the second exemplary corner padding method.

FIG. 22 is a diagram illustrating a geometry padding scheme for setting values of padding pixels in one corner area of a padding region according to the third exemplary corner padding method.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

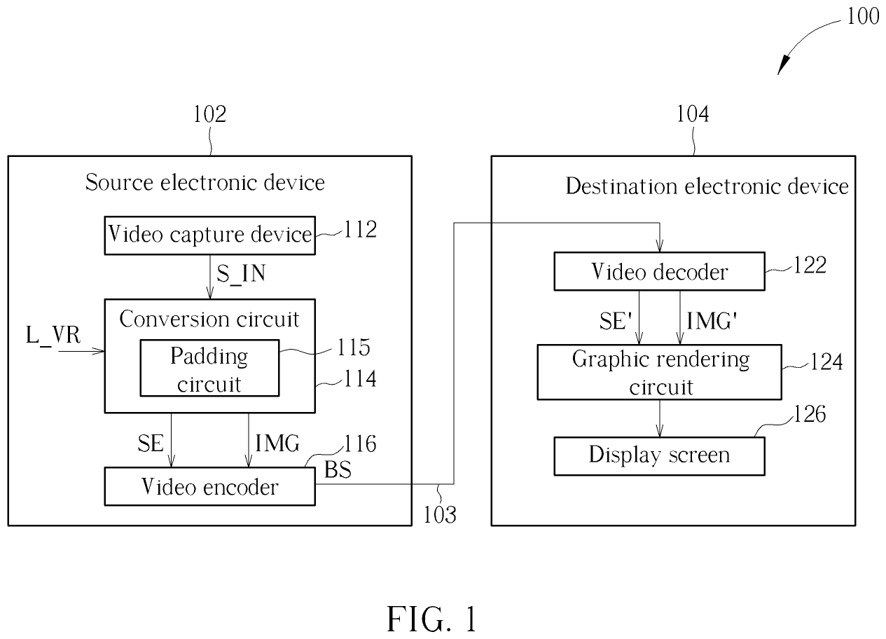

FIG. 1 is a diagram illustrating a 360-degree Virtual Reality (360 VR) system according to an embodiment of the present invention. The 360 VR system 100 includes two video processing apparatuses (e.g., a source electronic device 102 and a destination electronic device 104). The source electronic device 102 includes a video capture device 112, a conversion circuit 114, and a video encoder 116. For example, the video capture device 112 may be a set of cameras used to provide an omnidirectional image content (e.g., multiple images that cover the whole surroundings) S_IN corresponding to a sphere. The conversion circuit 114 is coupled between the video capture device 112 and the video encoder 116. The conversion circuit 114 generates a projection-based frame IMG with a 360-degree Virtual Reality (360 VR) projection layout L_VR according to the omnidirectional image content S_IN. For example, the projection-based frame IMG may be one frame included in a sequence of projection-based frames generated from the conversion circuit 114. The video encoder 116 is an encoding circuit used to encode/compress the projection-based frames IMG to generate a part of a bitstream BS. Further, the video encoder 116 outputs the bitstream BS to the destination electronic device 104 via a transmission means 103. For example, the sequence of projection-based frames may be encoded into the bitstream BS, and the transmission means 103 may be a wired/wireless communication link or a storage medium.

The destination electronic device 104 may be a head-mounted display (HMD) device. As shown in FIG. 1, the destination electronic device 104 includes a video decoder 122, a graphic rendering circuit 124, and a display screen 126. The video decoder 122 is a decoding circuit used to receive the bitstream BS from the transmission means 103 (e.g., wired/wireless communication link or storage medium), and decode apart of the received bitstream BS to generate a decoded frame IMG′. For example, the video decoder 122 generates a sequence of decoded frames by decoding the received bitstream BS, where the decoded frame IMG′ is one frame included in the sequence of decoded frames. In this embodiment, the projection-based frame IMG to be encoded at the encoder side has a 360 VR projection format with a projection layout. Hence, after the bitstream BS is decoded at the decoder side, the decoded frame IMG′ has the same 360 VR projection format and the same projection layout. The graphic rendering circuit 124 is coupled between the video decoder 122 and the display screen 126. The graphic rendering circuit 124 renders and displays an output image data on the display screen 126 according to the decoded frame IMG′. For example, a viewport area associated with a portion of the 360-degree image content carried by the decoded frame IMG′ may be displayed on the display screen 126 via the graphic rendering circuit 124.

As mentioned above, the conversion circuit 114 generates the projection-based frame IMG according to the 360 VR projection layout L_VR and the omnidirectional image content S_IN. In this embodiment, the 360 VR projection layout L_VR may be selected from a group consisting of a cube-based projection layout with padding (guard band(s)), a triangle-based projection layout with padding (guard band(s)), a segmented sphere projection layout with padding (guard band(s)), a rotated sphere projection layout with padding (guard band(s)), a viewport-dependent projection layout with padding (guard band(s)), an equi-rectangular projection layout with padding (guard band (s)), an equi-area projection layout with padding (guard band (s)), and an equatorial cylindrical projection layout with padding (guard band(s)). For example, the 360 VR projection layout L_VR may be set by a regular cubemap projection layout with padding (guard band(s)) or a hemisphere cubemap projection layout with padding (guard band(s)).

Consider a case where the 360 VR projection layout L_VR is a cube-based projection layout. Hence, at least a portion (i.e., part or all) of a 360-degree content of a sphere is mapped to projection faces via cube-based projection, and the projection faces derived from different faces of a three-dimensional object (e.g., a cube or a hemisphere cube) are packed in the two-dimensional cube-based projection layout that is employed by the projection-based frame IMG/decoded frame IMG′.

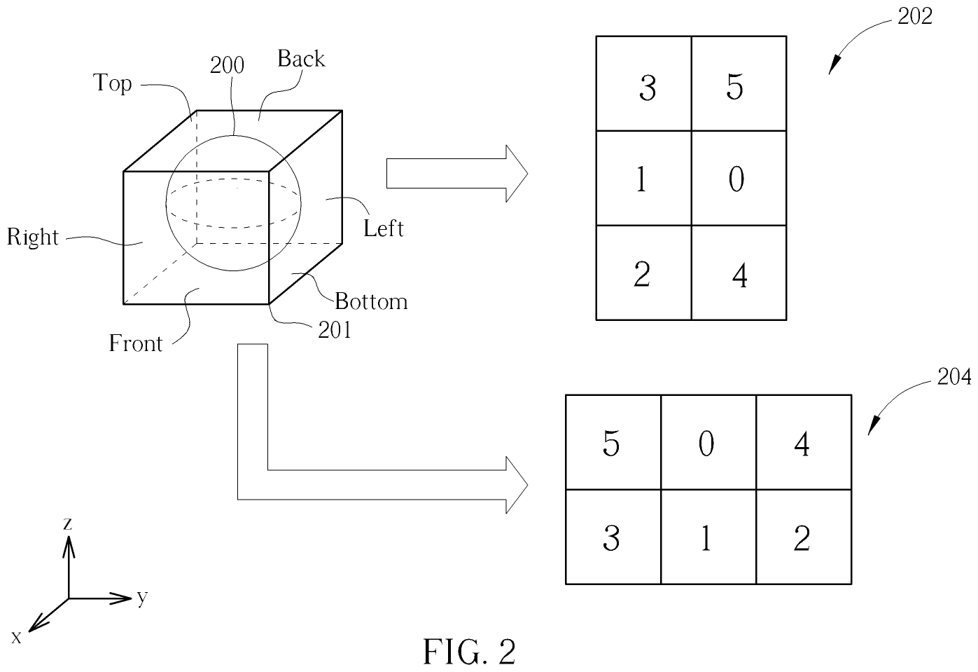

In one embodiment, cube-based projection with six square projection faces representing full 360°×180° omnidirectional video (i.e., all of a 360-degree content of a sphere) may be employed. Regarding the conversion circuit 114 of the source electronic device 102, cube-based projection is employed to generate square projection faces of a cube in a three-dimensional (3D) space. FIG. 2 is a diagram illustrating a cube-based projection according to an embodiment of the present invention. The whole 360-degree content on the sphere 200 is projected onto six square faces of a cube 201, including a top face (labeled by “Top”), a bottom face (labeled by “Bottom”), a left face (labeled by “Left”), a front face (labeled by “Front”), aright face (labeled by “Right”), and a back face (labeled by “Back”). As shown in FIG. 2, an image content of a north polar region of the sphere 200 is projected onto the top face “Top”, an image content of a south polar region of the sphere 200 is projected onto the bottom face “Bottom”, and an image content of an equatorial region of the sphere 200 is projected onto the left face “Left”, the front face “Front”, the right face “Right”, and the back face “Back”.

Forward transformation may be used to transform from the 3D space to the 2D plane . Hence, the top face “Top”, bottom face “Bottom”, left face “Left”, front face “Front”, right face “Right”, and back face “Back” of the cube 201 in the 3D space are transformed into a top face (labeled by “2”), a bottom face (labeled by “3”), a left face (labeled by “5”), a front face (labeled by “0”), a right face (labeled by “4”), and a back face (labeled by “1”) on the 2D plane.

Inverse transformation may be used to transform from the 2D plane to the 3D space. Hence, the top face (labeled by “2”) , the bottom face (labeled by “3”), the left face (labeled by “5”), the front face (labeled by “0”), the right face (labeled by “4”), and the back face (labeled by “1”) on the 2D plane are transformed into the top face “Top”, bottom face “Bottom”, left face “Left”, front face “Front”, right face “Right”, and back face “Back” of the cube 201 in the 3D space.

The inverse transformation can be employed by the conversion circuit 114 of the source electronic device 102 for generating the top face “2”, bottom face “3”, left face “5”, front face “0”, right face “4”, and back face “1”. The top face “2”, bottom face “3”, left face “5”, front face “0”, right face “4”, and back face “1” on the 2D plane are packed in the projection-based frame IMG to be encoded by the video encoder 116.

The video decoder 122 receives the bitstream BS from the transmission means 103, and decodes a part of the received bitstream BS to generate the decoded frame IMG′ that has the same projection layout L_VR adopted at the encoder side. Regarding the graphic rendering circuit 124 of the destination electronic device 104, forward transformation can be used to transform from the 3D space to the 2D plane for determining pixel values of pixels in any of the top face “Top”, bottom face “Bottom”, left face “Left”, front face “Front”, right face “Right”, and back face “Back”. Or the inverse transformation can be used to transform from the 2D plane to the 3D space for remapping the sample locations of a projection-based frame to the sphere.

As mentioned above, the top face “2”, bottom face “3”, left face “5”, front face “0”, right face “4”, and back face “1” are packed in the projection-based frame IMG. For example, the conversion circuit 114 may select one packing type, such that the projection-based frame IMG may have projected image data arranged in the cube-based projection layout 202. For another example, the conversion circuit 114 may select another packing type, such that the projection-based frame IMG may have projected image data arranged in the cube-based projection layout 204 that is different from the cube-based projection layout 202.

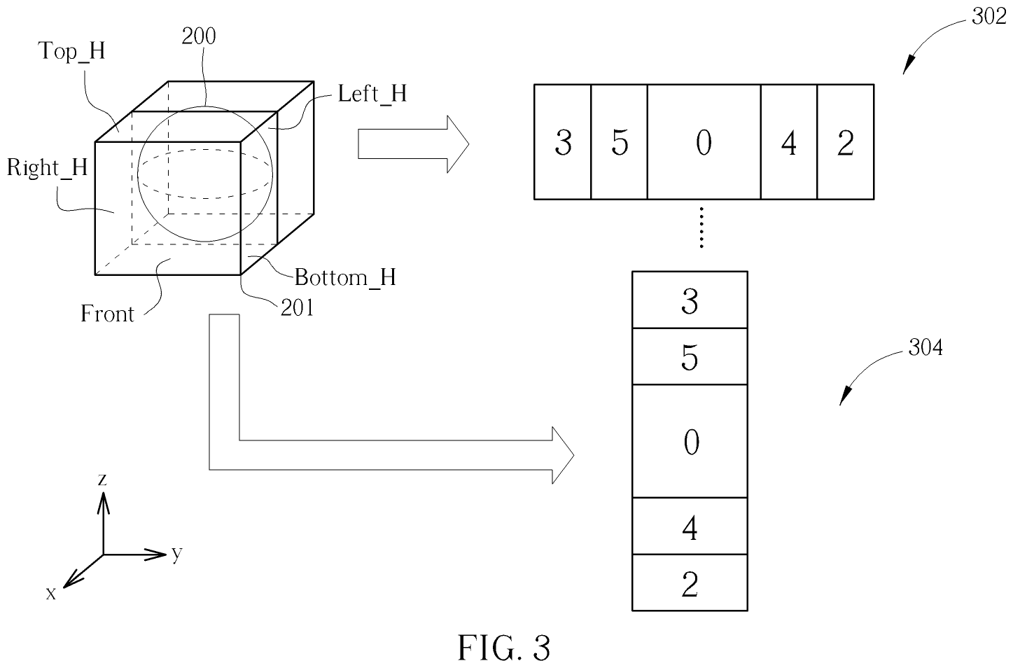

In another embodiment, cube-based projection with five projection faces (which include one full face and four half faces) representing 180°×180° omnidirectional video (i.e., part of a 360-degree content of a sphere) may be employed. Regarding the conversion circuit 114 of the source electronic device 102, cube-based projection is employed to generate one full face and four half faces of a cube in a 3D space. FIG. 3 is a diagram illustrating another cube-based projection according to an embodiment of the present invention. Only a half of the 360-degree content on the sphere 200 is projected onto faces of a cube 201, including a top half face (labeled by “Top_H”), a bottom half face (labeled by “Bottom_H”), a left half face (labeled by “Left_H”), a front full face (labeled by “Front”), and a right half face (labeled by “Right_H”). In this example, a hemisphere cube (e.g., a half of the cube 201) is employed for hemisphere cubemap projection, where a hemisphere (e.g., a half of the sphere 200) is inscribed in the hemisphere cube (e.g., half of the cube 201). As shown in FIG. 3, an image content of a half of a north polar region of the sphere 200 is projected onto the top half face “Top_H”, an image content of a half of a south polar region of the sphere 200 is projected onto the bottom half face “Bottom_H”, and an image content of a half of an equatorial region of the sphere 200 is projected onto the left half face “Left_H”, the front full face “Front”, and the right half face “Right_H”.

Forward transformation may be used to transform from the 3D space to the 2D plane. Hence, the top half face “Top_H”, bottom half face “Bottom_H”, left half face “Left_H”, front full face “Front”, and right half face “Right_H” of the cube 201 in the 3D space are transformed into a top half face (labeled by “2”), a bottom half face (labeled by “3”), a left half face (labeled by “5”), a front full face (labeled by “0”), and a right half face (labeled by “4”) on the 2D plane. In addition, a size of the front full face (labeled by “0”) is twice as large as a size of each of top half face (labeled by “2”), bottom half face (labeled by “3”), left half face (labeled by “5”), and right half face (labeled by “4”).

Inverse transformation may be used to transform from the 2D plane to the 3D space. Hence, the top half face (labeled by “2”), the bottom half face (labeled by “3”), the left half face (labeled by “5”), the front full face (labeled by “0”), and the right half face (labeled by “4”) on the 2D plane are transformed into the top half face “Top_H”, bottom half face “Bottom_H”, left half face “Left_H”, front full face “Front”, and right half face “Right_H” of the cube 201 in the 3D space.

The inverse transformation can be employed by the conversion circuit 114 of the source electronic device 102 for generating the top half face “2”, bottom half face “3”, left half face “5”, front full face “0”, and right half face “4”. The top half face “2”, bottom half face “3”, left half face “5”, front full face “0”, and right half face “4” on the 2D plane are packed in the projection-based frame IMG to be encoded by the video encoder 116.

The video decoder 122 receives the bitstream BS from the transmission means 103, and decodes a part of the received bitstream BS to generate the decoded frame IMG′ that has the same projection layout L_VR adopted at the encoder side. Regarding the graphic rendering circuit 124 of the destination electronic device 104, forward transformation can be used to transform from the 3D space to the 2D plane for determining pixel values of pixels in any of the top half face “Top_H”, bottom half face “Bottom_H”, left half face “Left_H”, front full face “Front”, and right half face “Right_H”. Or the inverse transformation can be used to transform from the 2D plane to the 3D space for remapping the sample locations of a projection-based frame to the sphere.

As mentioned above, the top half face “2”, bottom half face “3”, left half face “5”, front full face “0”, and right half face “4” are packed in the projection-based frame IMG. For example, the conversion circuit 114 may select one packing type, such that the projection-based frame IMG may have projected image data arranged in the cube-based projection layout 302. For another example, the conversion circuit 114 may select another packing type, such that the projection-based frame IMG may have projected image data arranged in the cube-based projection layout 304 that is different from the cube-based projection layout 302. In this embodiment, the front face is selected as the full face that is packed in the cube-based projection layout 302/304. In practice, the full face packed in the cube-based projection layout 302/304 may be any of the top face, the bottom face, the front face, the back face, the left face, and the right face, and the four half faces packed in the cube-based projection layout 302/304 depend on the selection of the full face.

Regarding the embodiment shown in FIG. 2, projection faces are packed in a regular CMP layout without guard bands (or padding) 202/204. Regarding the embodiment shown in FIG. 3, projection faces are packed in a hemisphere CMP layout without guard bands (or padding) 302/304. However, the projection-based frame IMG after coding may have artifacts due to discontinuous layout boundaries of the CMP layout (which may be a regular CMP layout or a hemisphere CMP layout) and/or discontinuous edges of the CMP layout (which may be a regular CMP layout or a hemisphere CMP layout). For example, the CMP layout without guard bands (or padding) has a top discontinuous layout boundary, a bottom discontinuous layout boundary, a left discontinuous layout boundary, and a right discontinuous layout boundary. In addition, there is at least one image content discontinuous edge between two adjacent projection faces packed in the CMP layout without guard bands (or padding). Taking the cube-based projection layout 202/204 for example, one discontinuous edge exists between one face boundary of the bottom face “3” and one face boundary of the left face “5” , one discontinuous edge exists between one face boundary of the back face “1” and one face boundary of the front face “0” , and one discontinuous edge exists between one face boundary of the top face “2” and one face boundary of the right face “4”. Taking the cube-based projection layout 302/304 for example, one discontinuous edge exists between one face boundary of the bottom face “3” and one face boundary of the left face “5” , and one discontinuous edge exists between one face boundary of the right face “4” and one face boundary of the top face “2”.

To address this issue, the 360 VR projection layout L_VR may be set by a projection layout with at least one guard band (or padding) such as a cube-based projection layout with guard bands (or padding). For example, around layout boundaries and/or discontinuous edges, additional guard bands may be inserted for reducing the seam artifacts. Alternatively, around layout boundaries and/or continuous edges, additional guard bands may be inserted. To put it simply, the location of each guard band added to a projection layout may depend on actual design considerations.

In this embodiment, the conversion circuit 114 has a padding circuit 115 that is arranged to fill guard band (s) with padding pixels. Hence, the conversion circuit 114 creates the projection-based frame IMG by packing at least one projection face and at least one guard band in the 360 VR projection layout L_VR. It should be noted that the number of projection faces depends on the employed projection format, and the number of guard bands depends on the employed guard band configuration. For example, when the employed projection format is cube-based projection, the conversion circuit 114 determines a guard band configuration of the projection-based frame IMG that consists of projection faces derived from cube-based projection (e.g., regular cubemap projection shown in FIG. 2 or hemisphere cubemap projection shown in FIG. 3), and the decoded frame IMG′ is a projection-based frame that is generated from the video decoder 122 and has a guard band configuration identical to that of the projection-based frame IMG received and encoded by the video encoder 116.

FIGS. 4-6 are diagrams illustrating one specification of guard bands packed in a regular cubemap projection or a hemisphere cubemap projection according to an embodiment of the present invention. As shown in a top part of FIG. 4, a first guard band is added to a bottom face boundary of a first projection face packed at a face position with the position index 2, and a second guard band is added to a top face boundary of a second projection face packed at a face position with the position index 3, where the first guard band and the second guard band have the same guard band size D (i.e., the same number of guard band samples). If the bottom face boundary of the first projection face directly connects with the top face boundary of the second projection face, an edge (e.g., a discontinuous edge or a continuous edge) exists between the first projection face and the second projection face. Guard bands can be added to the edge between the first projection face and the second projection face. For example, regarding a cube in a 3D space, the bottom face boundary of the first projection face (which is one square face of the cube) may be connected with or may not be connected with the top face boundary of the second projection face (which is another square face of the cube); and regarding a cube-based projection layout on a 2D plane, the bottom face boundary of the first projection face is parallel with the top face boundary of the second projection face, and the first guard band and the second guard band are both between the first projection face and the second projection face for isolating the bottom face boundary of the first projection face from the top face boundary of the second projection face, where the first guard band connects with the bottom face boundary of the first projection face and the second guard band, and the second guard band connects with the first guard band and the top face boundary of the second projection face. Hence, the width of one guard band area (which consists of the first guard band and the second guard) inserted between the first projection face (which is packed at the face position with the position index 2) and the second projection face (which is packed at the face position with the position index 3) is equal to 2*D.

As shown in a bottom part of FIG. 4, a first guard band is added to a bottom face boundary of a projection face packed at a face position with the position index 2, a second guard band is added to a top face boundary of a projection face packed at a face position with the position index 3, a third guard band is added to a top face boundary of a projection face packed at a face position with the position index 0, a fourth guard band is added to a bottom face boundary of a projection face packed at a face position with the position index 5, a fifth guard band is added to left face boundaries of projection faces packed at face positions with the position indexes 0-5, and a sixth guard band is added to right face boundaries of projection faces packed at face positions with the position indexes 0-5, where the first guard band, the second guard band, the third guard band, the fourth guard band, the fifth guard band, and the sixth guard band have the same guard band size D (i.e., the same number of guard band samples). Specifically, the third guard band, the fourth guard band, the fifth guard band, and the sixth guard band act as boundaries of the cube-based projection layout. In addition, the width of one guard band area (which consists of two guard bands) inserted between two projection faces (which are packed at face positions with position indexes 2 and 3) is equal to 2*D.

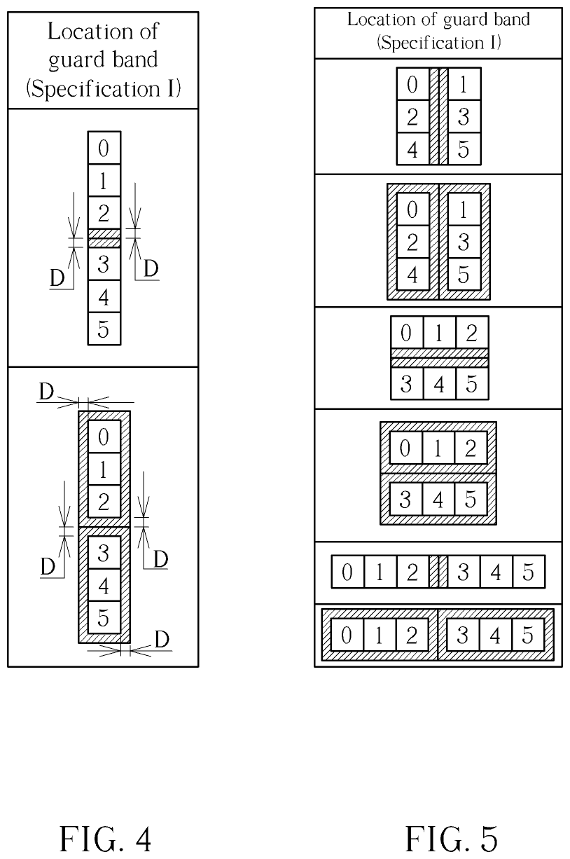

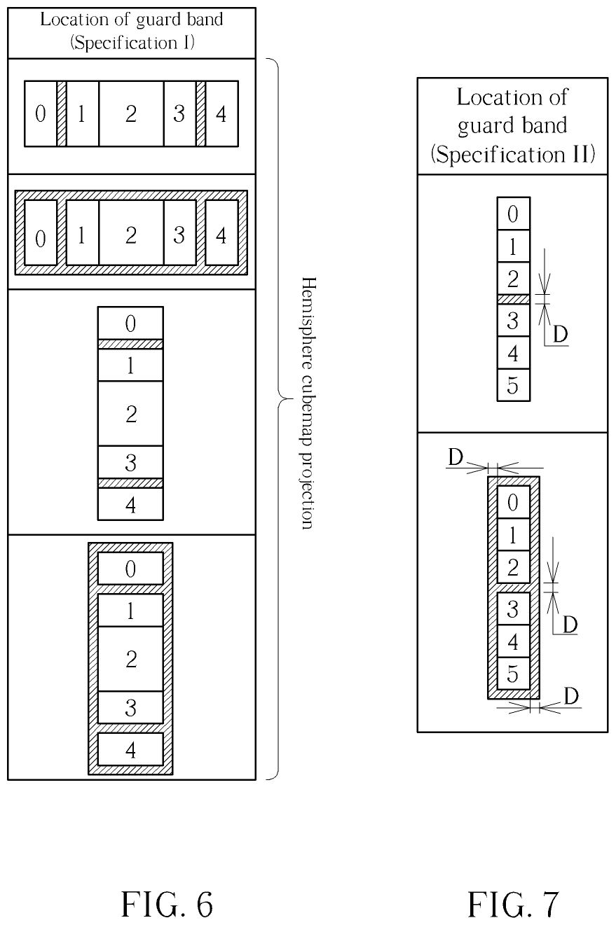

Since a person skilled in the art can readily understand details of other guard band configurations shown in FIG. 5 and FIG. 6 after reading above paragraphs, further description is omitted here for brevity.

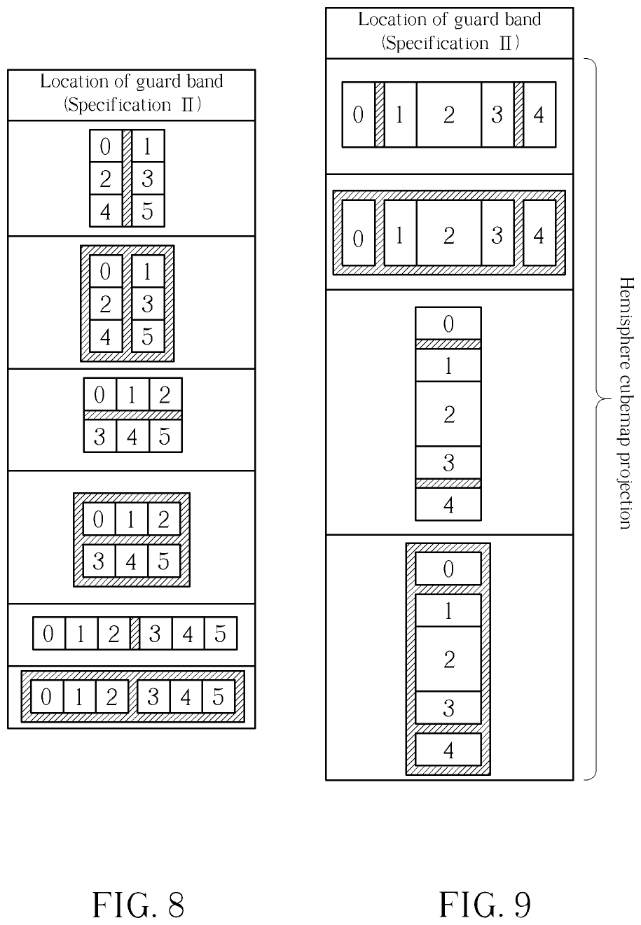

FIGS. 7-9 are diagrams illustrating another specification of guard bands packed in a regular cubemap projection or a hemisphere cubemap projection according to an embodiment of the present invention. The major difference between the guard band configurations shown in FIGS. 4-6 and the guard band configurations shown in FIGS. 7-9 is that a single guard band is added to an edge (e.g., a discontinuous edge or a continuous edge) between two adjacent projection faces packed in a cube-based projection layout.

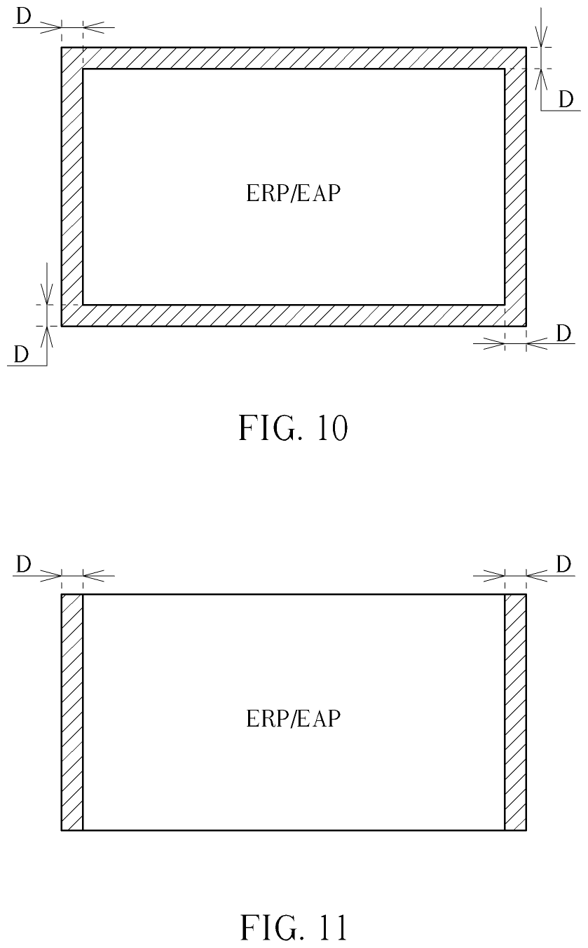

In addition to a projection layout with multiple projection faces packed therein, a projection layout with a single projection face packed therein may also have guard band(s) added by the padding circuit 115. FIG. 10 is a diagram illustrating one specification of guard bands packed in an equi-rectangular projection (ERP) layout or an equi-area projection (EAP) layout according to an embodiment of the present invention. A first guard band is added to a top face boundary of the single projection face (which is also a top layout boundary of the ERP/EAP layout), a second guard band is added to a left face boundary of the single projection face (which is also a left layout boundary of the ERP/EAP layout), a third guard band is added to a bottom face boundary of the single projection face (which is also a bottom layout boundary of the ERP/EAP layout), and a fourth guard band is added to a right face boundary of the single projection face (which is also a right layout boundary of the ERP/EAP layout), where the first guard band, the second guard band, the third guard band, and the fourth guard band have the same guard band size D (i.e., the same number of guard band samples).

FIG. 11 is a diagram illustrating another specification of guard bands packed in an equi-rectangular projection layout or an equi-area projection layout according to an embodiment of the present invention. A first guard band is added to a left face boundary of the single projection face (which is also a left layout boundary of the ERP/EAP layout), and a second guard band is added to a right face boundary of the single projection face (which is also a right layout boundary of the ERP/EAP layout), where the first guard band and the second guard band have the same guard band size D (i.e., the same number of guard band samples).

In this embodiment, the conversion circuit 114 determines a guard band configuration of the projection-based frame IMG that consists of one or more projection faces, and the video encoder 116 signals syntax element(s) SE associated with the guard band configuration of the projection-based frame IMG via the bitstream BS. Hence, the video decoder 122 can parse the syntax element(s) SE associated with the guard band configuration from the bitstream BS.

For example, the syntax element(s) SE associated with the guard band configuration of the projection-based frame (e.g., IMG or IMG′) with the cube-based projection layout may include gcmp_guard_band_flag, gcmp_guard_type, gcmp_guard_band_boundary_exterior_flag, and gcmp_guard_band_samples_minus1. The syntax element gcmp_guard_band_flag is arranged to indicate whether a projection-based frame (e.g., IMG or IMG′) contains at least one guard band. If the syntax element gcmp_guard_band_flag is equal to 0, it indicates that the coded picture does not contain guard band areas. If the syntax element gcmp_guard_band_flag is equal to 1, it indicates that the coded picture contains guard band area (s) for which the size (s) are specified by the syntax element gcmp_guard_band_samples_minus1. The syntax element gcmp_guard_band_boundary_exterior_flag is arranged to indicate whether at least one guard band packed in the projection-based frame (e.g., IMG or IMG′) includes guard bands that act as boundaries of the cube-based projection layout. The syntax element gcmp_guard_band_samples_minus1 is arranged to provide size information of each guard band packed in the projection-based frame (e.g., IMGorIMG′). For example, gcmp_guard_band_samples_minus1 plus 1 specifies the number of guard band samples, in units of luma samples, used in the cubemap projected picture. The syntax element gcmp_guard_type specifies the type of the guard bands when the guard band is enabled (i.e., gcmp_guard_band_flag==1).

Ideally, syntax element(s) SE encoded into the bitstream BS by the video encoder 116 are the same as the syntax element(s) SE′ parsed from the bitstream BS by the video decoder 122. Hence, the video encoder 116 may employ the proposed syntax signaling method to signal a syntax element indicative of a guard band type of guard band(s) added by the conversion circuit 114 (particularly, padding circuit 115), and the video decoder 122 may parse the syntax element signaled by the proposed syntax signaling method employed by the video encoder 116 and may provide the graphic rendering circuit 124 with the parsed syntax element, such that the graphic rendering circuit 124 is informed of the guard band type of guard band(s) added by the conversion circuit 114 (particularly, padding circuit 115). In this way, when determining an image content of a viewport area selected by a user, the graphic rendering circuit 124 can refer to the guard band type for using guard band samples in a rendering process and/or a post-processing process to improve the video quality.

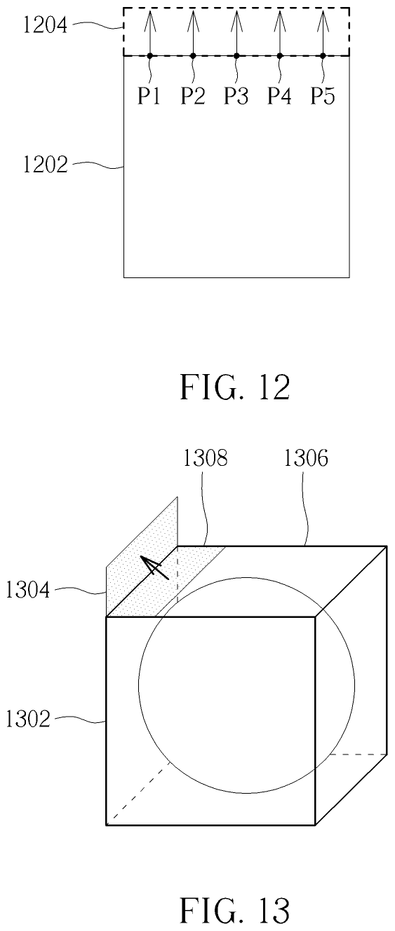

For example, a generation type of guard band samples may be repetitive padding of boundary pixels of a projection face from which one guard band is extended. FIG. 12 is a diagram illustrating a first guard band type according to an embodiment of the present invention. In this example, a guard band 1204 is extended from a projection face 1202 (e.g., one of the projection faces shown in FIGS. 4-11). The boundary pixels (e.g. , P1, P2, P3, P4, and P5) of the projection face 1202 are duplicated to create padding pixels included in the guard band 1204. Consider a case where the guard band 1204 and the projection face 1202 are vertically arranged in the projection-based frame IMG/IMG′. When a padding pixel of the guard band 1204 and a boundary pixel of the projection face 1202 are located at the same pixel column, the padding pixel of the guard band 1204 is a duplicate of the boundary pixel of the projection face 1202. That is, a value of the padding pixel of the guard band 1204 is the same as a value of the boundary pixel of the projection face 1202. Consider another case where the guard band 1204 and the projection face 1202 are horizontally arranged in the projection-based frame IMG/IMG′. When a padding pixel of the guard band 1204 and a boundary pixel of the projection face 1202 are located at the same pixel row, the padding pixel of the guard band 1204 is a duplicate of the boundary pixel of the projection face 1202. That is, a value of the padding pixel of the guard band 1204 is the same as a value of the boundary pixel of the projection face 1202.

For another example, a generation type of guard band samples may be copying a guard band that is extended from one side of a projection face from a spherically neighboring projection face of the projection face if the projection-based frame IMG/IMG′ has multiple projection faces packed therein (or copying a guard band that is extended from one side of a projection face from a partial image on another side of the projection face if the projection-based frame IMG/IMG′ has only a single projection face packed therein). FIG. 13 is a diagram illustrating a second guard band type according to an embodiment of the present invention. Taking cube-based projection for example, a guard band 1304 is extended from a projection face 1302 (e.g. , a right face of a cube). Since the projection face 1302 is spherically adjacent to a projection face 1306 (e.g., a top face of the cube) in the 3D space, a partial image 1308 of the spherically neighboring projection face 1306 is copied to set the guard band 1304 packed in a cube-based projection layout on a 2D plane. That is, an image content of the guard band 1304 extended from the projection face 1302 is the same as an image content of the partial image 1308 included in the projection face 1306, where one side of the projection face 1302 and one side of the projection face 1306 are adjacent to each other when the projections 1302 and 1306 are two faces of the cube in the 3D space, but may not be adjacent to each other when the projections 1302 and 1306 are packed in the cube-based projection layout on the 2D plane.

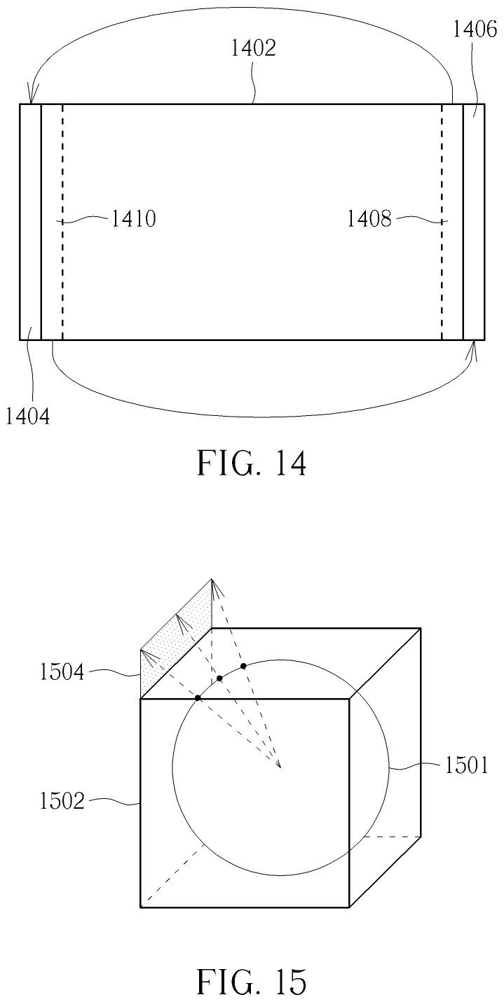

FIG. 14 is a diagram illustrating a second guard band type according to another embodiment of the present invention. Taking ERP/EAP projection for example, a guard band 1404 is extended from a left side of a projection face 1402, and a guard band 1406 is extended from a right side of the projection face 1402. Due to inherent characteristics of the 360-degree video, a partial image 1408 of the projection face 1402 is spherically adjacent to the partial image 1410 of the projection face 1402. That is, continuous image contents are presented in the partial images 1408 and 1410. Hence, the partial image 1408 on the right side of the projection face 1402 is copied to set the guard band 1404 extended from the left side of the projection face 1402, and the partial image 1410 on the left side of the projection face 1402 is copied to set the guard band 1406 extended from the right side of the projection face 1402.

For yet another example, a generation type of guard band samples may be deriving a guard band from geometry padding of a projection face from which the guard band is extended. FIG. 15 is a diagram illustrating a third guard band type according to an embodiment of the present invention. Taking cube-based projection for example, a guard band 1504 is extended from a projection face 1502, and is derived from applying geometry padding to the projection face 1502, where a geometry mapping region (i.e., guard band 1504) is a padding region obtained from mapping the content of a region on a sphere 1501 onto the padding region, and the region on the sphere 1501 is adjacent to a region on the sphere 1501 from which the projection face 1502 is obtained. Hence, there is an image content continuity boundary between the projection face 1502 and the geometry mapping region (i.e., guard band 1504) extended from the projection face 1502. Supposing that spheres shown in FIG. 13 and FIG. 15 have the same omnidirectional content, an image content of the guard band 1504 derived from geometry padding may be different from an image content of the guard band 1304 derived from copying the partial image 1308 on the projection face 1306.

Suppose that the 360 VR projection layout L_VR is set by a cube-based projection layout. The syntax element(s) SE associated with the guard band configuration of the projection-based frame IMG may include the syntax element gcmp_guard_band_type that is used to specify the type of guard band (s) when guard band (s) are enabled (i.e., gcmp_guard_band_flag==1). For example, the syntax element gcmp_guard_band_type indicates the type of the guard bands as follows:

gcmp_guard_band_type equal to 0 indicates that the content of the guard bands in relation to the content of the coded face is unspecified.

gcmp_guard_band_type equal to 1 indicates that the content of the guard bands suffices for interpolation of sample values at sub-pel sample fractional locations within the coded face.

NOTE—gcmp_guard_band_type equal to 1 could be used when the boundary samples of a coded face have been copied horizontally or vertically to the guard band.

gcmp_guard_band_type equal to 2 indicates that the content of the guard bands represents actual picture content that is spherically adjacent to the content in the coded face at quality that gradually changes from the picture quality of the coded face to that of the spherically adjacent region.

gcmp_guard_band_type equal to 3 indicates that the content of the guard bands represents actual picture content that is spherically adjacent to the content in the coded face at a similar picture quality as within the coded face.

gcmp_guard_band_type values greater than 3 are reserved for future use by ITU-T|ISO/IEC. Decoders shall treat the value of gcmp_guard_band_type when the value is greater than 3 as equivalent to the value 0.

Specifically, gcmp_guard_band_type equal to 1 specifies that the first guard band type illustrated in FIG. 12 is selected by the conversion circuit 114 (particularly, padding circuit 115); gcmp_guard_band_type equal to 2 specifies that the second guard band type illustrated in FIG. 13 is selected by the conversion circuit 114 (particularly, padding circuit 115); and gcmp_guard_band_type equal to 3 specifies that the third guard band type illustrated in FIG. 15 is selected by the conversion circuit 114 (particularly, padding circuit 115).

It should be noted that signaling of the guard band type from the source electronic device 102 to the destination electronic device 104 is not limited to the application of setting the 360 VR projection layout L_VR by a cube-based projection layout with padding (guard band(s)). In practice, the proposed signaling of the guard band type from the source electronic device 102 to the destination electronic device 104 may be applicable for the application of setting the 360 VR projection layout L_VR by any projection layout with padding (guard band(s)). These alternative designs all fall within the scope of the present invention.

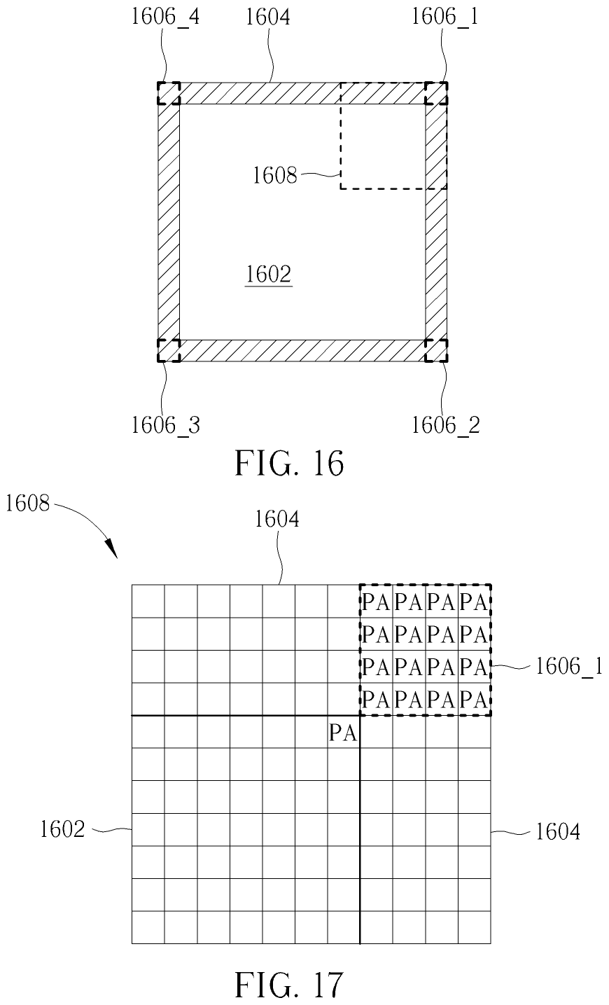

Regarding the 360 VR projection layout L_VR on a 2D plane, padding (or guard band(s)) can be added between faces and/or around a face or a frame to reduce seam artifacts in a reconstructed frame or viewport. The projection layout with padding (guard band(s)) may include a padding region consisting of guard band(s) filled with padding pixels and a non-padding region consisting of projection face(s) derived from applying projection to an omnidirectional content of a sphere. Regarding certain projection layouts, the padding region may have one or more corner areas each being located at the intersection of two guard bands (e.g., one vertical guard band and one horizontal guard band). FIG. 16 is a diagram illustrating a padding region with corners filled with padding pixels according to an embodiment of the present invention. In this embodiment, the projection-based frame IMG/IMG′ has a non-padding region 1602 that is surrounded by a padding region 1604. One or more projection faces may be packed in the non-padding region 1602. In addition, guard bands are packed in the padding region 1604. For example, a single projection face may be packed in the non-padding region 1602 that is a partial non-padding region of the projection-based frame IMG/IMG′ with the 360 VR projection layout L_VR set by, for example, the cube-based projection layout. For another example, all projection faces may be packed in the non-padding region 1602 that is a full non-padding region of the projection-based frame IMG/IMG′ with the 360 VR projection layout L_VR set by, for example, the cube-based projection layout. For yet another example, a single projection face may be packed in the non-padding region 1602 that is a full non-padding region of the projection-based frame IMG/IMG′ with the 360 VR projection layout L_VR set by, for example, the ERP/EAP layout. As shown in FIG. 16, the padding region 1604 is filled with padding pixels to form guard bands around boundaries of the non-padding region 1602, and has four corner areas including a top-right corner area 1606_1, a bottom-right corner area 1606_2, a bottom-left corner area 1606_3, and a top-left corner area 1606_4. The values of padding pixels in each corner area 1606_1, 1606_2, 1606_3, 1606_4 can be set by one of the proposed corner padding methods.

In accordance with a first exemplary corner padding method, duplication is employed to set values of padding pixels in one corner area of a padding region. FIG. 17 is a diagram illustrating a first duplication scheme for setting values of padding pixels in one corner area of a padding region according to the first exemplary corner padding method. An enlarged view of a partial image 1608 in FIG. 16 is illustrated in FIG. 17. The corner area 1606_1 is a top-right corner padding region having a size of 4×4. In this embodiment, all padding pixels in the corner area 1601_1 of the padding region 1604 have the same value that is equal to a value of a specific pixel included in the non-padding region 1602. That is, one pixel included in the non-padding region 1602 is duplicated to set each of the padding pixels included in the corner area 1601_1. By way of example, but not limitation, the specific pixel may be a corner pixel PA of the non-padding region 1602 that is nearest to the corner area 1606_1 of the padding region 1604. That is, all of the padding pixels in the top-right corner padding region is set by the value of the top-right corner pixel of the non-padding region 1602. Since a person skilled in the art can readily understand details of setting other corner padding regions by using the proposed duplication scheme, further description is omitted here for brevity.

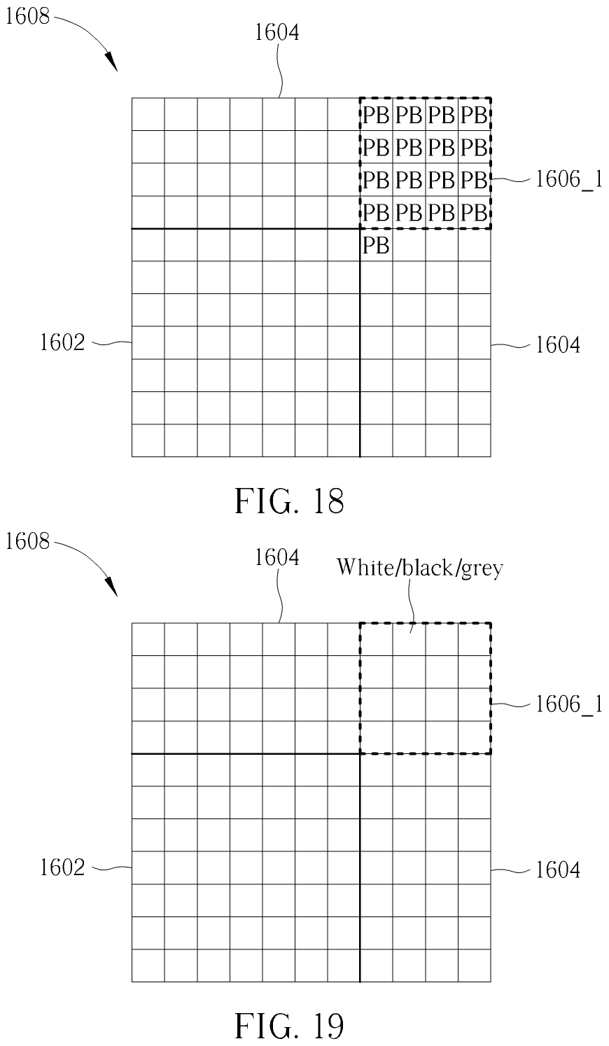

FIG. 18 is a diagram illustrating a second duplication scheme for setting values of padding pixels in one corner area of a padding region according to the first exemplary corner padding method. An enlarged view of the partial image 1608 in FIG. 16 is illustrated in FIG. 18. The corner area 1606_1 is a top-right corner padding region having a size of 4×4. In this embodiment, all padding pixels in the corner area 1601_1 of the padding region 1604 have the same value that is equal to a value of a specific pixel included in the padding region 1604, where the specific pixel is outside the corner area 1601_1 of the padding region 1604. That is, one padding pixel included in a non-corner area of the padding region 1604 is duplicated to set each of the padding pixels in the corner area 1601_1. By way of example, but not limitation, all of the padding pixels in the corner area 1601_1 of the padding region 1604 may be set by the value of the padding pixel PB in the padding region 1604. Since a person skilled in the art can readily understand details of setting other corner padding regions by using the proposed duplication scheme, further description is omitted here for brevity.

FIG. 19 is a diagram illustrating a third duplication scheme for setting values of padding pixels in one corner area of a padding region according to the first exemplary corner padding method. An enlarged view of the partial image 1608 in FIG. 16 is illustrated in FIG. 19. The corner area 1606_1 is a top-right corner padding region having a size of 4×4. In this embodiment, all padding pixels in the corner area 1601_1 of the padding region 1604 have the same value that is a pre-defined value, where the pre-defined value is independent of values of pixels in the non-padding region 1602 and pixels in the non-corner areas of the padding region 1604. That is, the same pre-defined value is duplicated to set values of all padding pixels in the corner area 1601_1. By way of example, but not limitation, all of the padding pixels in the corner area 1601_1 of the padding region 1604 may be colored by white, black, or grey. Since a person skilled in the art can readily understand details of setting other corner padding regions by using the proposed duplication scheme, further description is omitted here for brevity.

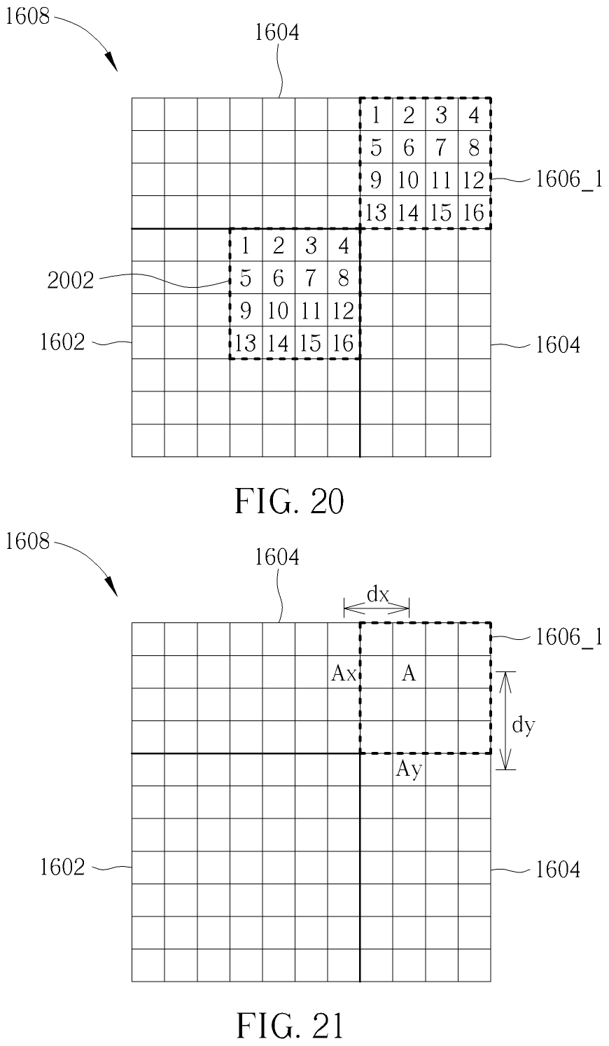

FIG. 20 is a diagram illustrating a fourth duplication scheme for setting values of padding pixels in one corner area of a padding region according to the first exemplary corner padding method. An enlarged view of the partial image 1608 shown in FIG. 16 is illustrated in FIG. 20. The corner area 1606_1 is a top-right corner padding region having a size of 4×4. In this embodiment, the corner area 1606_1 of the padding region 1604 is a duplicate of an area that is outside the corner area 1606_1. For example, the 4×4 top-right area 2002 consisting of pixels “1”-“16” in the non-padding region 1602 is duplicated to set the corner area 1606_1. In some embodiments of the present invention, a duplicate of the 4×4 top-right area 2002 may be rotated and/or flipped before being filled into the corner area 1606_1 of the padding region 1604. Since a person skilled in the art can readily understand details of setting other corner padding regions by using the proposed duplication scheme, further description is omitted here for brevity.

In accordance with a second exemplary corner padding method, blending is employed to set values of padding pixels in one corner area of a padding region. FIG. 21 is a diagram illustrating a blending scheme for setting values of padding pixels in one corner area of a padding region according to the second exemplary corner padding method. An enlarged view of the partial image 1608 in FIG. 16 is illustrated in FIG. 21. The corner area 1606_1 is a top-right corner padding region having a size of 4×4. Each padding pixel in the corner area 1606_1 of the padding region 1604 is set by a blending result of pixels outside the corner area 1606_1. For example, regarding setting of a padding pixel A included in the corner area 1606_1, pixels outside the corner area 1606_1 include pixels (Aₓ, A_{y}) in a horizontal direction (e.g., X-axis) and a vertical direction (e.g., Y-axis) that are nearest to the padding pixel A in the corner area 1601_1 . A distance based weighting function may be employed to determine a blending result. For example, a value of the padding pixel A may be set by using the following formula:

$$A = \frac{{A}_{y} \times {d}_{x} + {A}_{x} \times {d}_{y}}{{d}_{x} + {d}_{y}} ,$$

where dₓ represents a distance between A and Aₓ in the horizontal direction (e.g., X-axis) , and d_{y} represents a distance between A and A_{y} in the vertical direction (e.g., Y-axis). Since a person skilled in the art can readily understand details of setting other corner padding regions by using the proposed blending scheme, further description is omitted here for brevity.

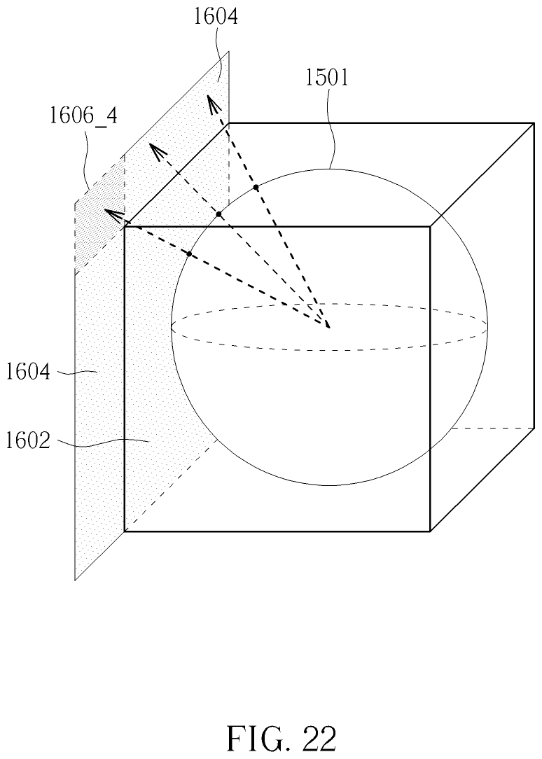

In accordance with a third exemplary corner padding method, geometry padding is employed to set values of padding pixels in one corner area of a padding region. FIG. 22 is a diagram illustrating a geometry padding scheme for setting values of padding pixels in one corner area of a padding region according to the third exemplary corner padding method. In this embodiment, all padding pixels in a corner area (e.g., 1606_4) of the padding region 1604 are derived from geometry padding, where a geometry mapping region (i.e., corner area 1606_4) is a corner padding region obtained from mapping the content of a region on the sphere 1501 onto the corner padding region, and the region on the sphere 1501 is adjacent to a region on the sphere 1501 from which a non-corner padding region (e.g. , a non-corner area of the padding region 1604) is obtained. Since a person skilled in the art can readily understand details of setting other corner padding regions by using the proposed geometry mapping scheme, further description is omitted here for brevity.

In some embodiments of the present invention, the conversion circuit 114 may select one of the proposed corner padding methods in response to the selected guard band type. In a case where the syntax element gcmp_guard_band_type is equal to 1, the first exemplary corner padding method is employed to set values of padding pixels in one corner area of a padding region by duplication. Hence, one of the duplication schemes shown in FIGS. 17-20 may be selected for corner padding. In a case where the syntax element gcmp_guard_band_type is equal to 2, the second exemplary corner padding method is employed to set values of padding pixels in one corner area of a padding region by blending. Hence, the blending scheme shown in FIG. 21 may be selected for corner padding. In a case where the syntax element gcmp_guard_band_type is equal to 3, the third exemplary corner padding method is employed to set values of padding pixels in one corner area of a padding region by geometry padding. Hence, the geometry padding scheme shown in FIG. 22 may be selected for corner padding. However, these are for illustrative purposes only, and are not meant to be limitations of the present invention. In practice, any projection layout with corner padding generated by using any of the proposed corner padding methods falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video decoding method comprising:
decoding a part of a bitstream to generate a decoded frame, comprising:
parsing a syntax element from the bitstream;
wherein the decoded frame is a projection-based frame that comprises at least one projection face and at least one guard band packed in a projection layout with padding, and at least a portion of a 360-degree content of a sphere is mapped to said at least one projection face via projection; and
wherein the syntax element specifies a guard band type of said at least one guard band.

2. The video decoding method of claim 1, wherein said at least one projection face comprises a plurality of projection faces that are derived from cube-based projection, and the projection layout with padding is a cube-based projection layout with padding.

3. The video decoding method of claim 1, wherein the syntax element is equal to a value indicating that the guard band type of said at least one guard band is repetitive padding of boundary pixels of a projection face from which each of said at least one guard band is extended.

4. The video decoding method of claim 3, wherein the cube-based projection layout with padding comprises a padding region and a non-padding region, said at least one projection face is packed in the non-padding region, said at least one guard band is packed in the padding region, and all padding pixels in a corner area of the padding region have a same value.

5. The video decoding method of claim 4, wherein said same value is equal to a value of a specific pixel included in the non-padding region.

6. The video decoding method of claim 5, wherein the specific pixel is a corner pixel of the non-padding region that is nearest to the corner area of the padding region.

7. The video decoding method of claim 4, wherein said same value is equal to a value of a specific pixel in the padding region, where the specific pixel is outside the corner area of the padding region.

8. The video decoding method of claim 4, wherein said same value is a pre-defined value.

9. The video decoding method of claim 3, wherein the cube-based projection layout with padding comprises a padding region and a non-padding region, said at least one projection face is packed in the non-padding region, said at least one guard band is packed in the padding region, and a corner area of the padding region comprises a plurality of padding pixels and is a duplicate of an area that is outside the corner area of the padding region.

10. The video decoding method of claim 1, wherein the syntax element is equal to a value indicating that the guard band type of said at least one guard band is copying each of said at least one guard band that is extended from one side of a projection face from a spherically neighboring projection face of the projection face or the guard band type of said at least one guard band is copying each of said at least one guard band that is extended from one side of a projection face from a partial image on another side of the projection face.

11. The video decoding method of claim 10, wherein the cube-based projection layout with padding comprises a padding region and a non-padding region, said at least one projection face is packed in the non-padding region, said at least one guard band is packed in the padding region, and each padding pixel in a corner area of the padding region is set by a blending result of pixels outside the corner area.

12. The video decoding method of claim 11, wherein the pixels outside the corner area comprise pixels in a horizontal direction and a vertical direction that are nearest to said each padding pixel in the corner area.

13. The video decoding method of claim 1, wherein the syntax element is equal to a value indicating that the guard band type of said at least one guard band is deriving each of said at least one guard band from geometry padding of a projection face from which said each of said at least one guard band is extended.

14. The video decoding method of claim 13, wherein the cube-based projection layout with padding comprises a padding region and a non-padding region, said at least one projection face is packed in the non-padding region, said at least one guard band is packed in the padding region, and all padding pixels in a corner area of the padding region are derived from geometry padding.

15. A video decoding method comprising:
decoding a part of a bitstream to generate a decoded frame;
wherein the decoded frame is a projection-based frame that comprises at least one projection face and at least one guard band packed in a projection layout with padding, and at least a portion of a 360-degree content of a sphere is mapped to said at least one projection face via projection; and
wherein the projection layout with padding comprises a padding region and a non-padding region, said at least one projection face is packed in the non-padding region, said at least one guard band is packed in the padding region, and all padding pixels in a corner area of the padding region have a same value.

16. The video decoding method of claim 15, wherein said same value is equal to a value of a specific pixel included in the non-padding region.

17. The video decoding method of claim 16, wherein the specific pixel is a corner pixel of the non-padding region that is nearest to the corner area of the padding region.

18. The video decoding method of claim 15, wherein said same value is equal to a value of a specific pixel in the padding region, where the specific pixel is outside the corner area of the padding region.

19. The video decoding method of claim 15, wherein said same value is a pre-defined value.

20. A video decoding method comprising:
decoding a part of a bitstream to generate a decoded frame;
wherein the decoded frame is a projection-based frame that comprises at least one projection face and at least one guard band packed in a projection layout with padding, and at least a portion of a 360-degree content of a sphere is mapped to said at least one projection face via projection; and
wherein the projection layout with padding comprises a padding region and a non-padding region, said at least one projection face is packed in the non-padding region, said at least one guard band is packed in the padding region, and a corner area of the padding region comprises a plurality of padding pixels and is a duplicate of an area that is outside the corner area of the padding region.
